(19) United States
(12) Patent Application Publication
(10) Pub. No.: US 2018/0154921 A1
(43) Pub. Date: Jun. 7, 2018

(54) FOLDING STEERING WHEEL

(71) Applicant: FORD GLOBAL TECHNOLOGIES, LLC, Dearborn, MI (US)

(72) Inventors: Frank Victor Bonello, Carleton, MI (US); Peter Nicholas Kalergis, Canton, MI (US)

(21) Appl. No.: 15/370,562

(22) Filed: Dec. 6, 2016

(51) Int. Cl. B62D 1/06

(52) U.S. Cl. CPC B62D 1/06

(57) ABSTRACT

A folding steering wheel includes a first section, a second section and a pivot. The pivot connects the first section to the second section. The first section is displaced about the pivot between a home position and a folded position. A related method of converting a steering wheel into a support surface for a laptop computer or other device is also disclosed.

### TECHNICAL FIELD

This document relates generally to the motor vehicle equipment field and, more particularly, to a folding steering wheel wherein a first section of the steering wheel may be folded with respect to a second section into a substantially horizontal plane so as to form a support base for a laptop computer or other device allowing convenient operation of the laptop computer or other device from a seated position in the driver's seat of the motor vehicle.

### BACKGROUND

Many individuals utilize their motor vehicles for work. Often these individuals need to utilize a laptop computer or other device for a work related task. Many times, these individuals need to complete some work after arriving at a meeting early, while waiting to pick someone up or following a meeting.

This document relates to a new and improved folding steering wheel. A first section of that steering wheel may be displaced from a home or steering wheel operating position to a folded or device supporting position wherein the first section of the steering wheel extends in a substantially horizontal plane. In this folded position, the first section of the steering wheel will support a laptop computer or other device in a convenient position for use while one is sitting in the driver's seat of the motor vehicle.

### SUMMARY

In accordance with the purposes and benefits described herein, a folding steering wheel is provided. That folding steering wheel comprises a first section, a second section and a pivot. The pivot connects the first section to the second section. The first section folds about the pivot and is displaced with respect to the second section between a home position, wherein the first and second sections form a complete steering wheel for operating the motor vehicle and a folded position wherein the first section extends substantially in a horizontal plane. In the folded position, the first section forms a support for a laptop computer or other device thereby allowing an operator seated in the motor vehicle driver's seat to complete work in a convenient and efficient manner.

The folded steering wheel may also include a lock that releasably secures the first section in the home position for proper motor vehicle operation. That pivot may comprise a first pivot pin aligned with a second pivot pin wherein the two pivot pins are at opposite sides of the steering wheel rim.

In addition, the folding steering wheel may include a damper spring received around the first pivot pin. The damper spring functions to allow the first section to slowly and smoothly move into the folded position from the home position. The lock may include a first locking lever having a first locking lug at a first end. Further, the folding steering wheel may include a first fulcrum about which that first lever pivots. In addition, the folding steering wheel may include a first return spring for biasing the first locking lever into the first locking position.

Still further, the lock may include a second locking lever having a second locking lug at a second end. Further, the folding steering wheel may include a second fulcrum about which the second lever pivots. Additionally, the folding steering wheel may include a second return spring for biasing the second locking lever into a second locking position.

Still further, the folding steering wheel may include a hub that is carried on the second section.

In accordance with an additional aspect, a method is provided of converting a steering wheel into a support surface for a laptop computer or other device. That method comprises the step of folding a first section of the steering wheel with respect to a second section of the steering wheel until the first section of the steering wheel extends in a substantially horizontal plane.

The method may further include the step of releasing a lock that secures the first section of the steering wheel in a home position before folding that first section of the steering wheel into a folded position extending in the substantially horizontal plane. In addition, the method may include the step of positioning the laptop computer or other device on top of the first section of the steering wheel when that first section is in the folded position. In this position the laptop or other device is easily accessed by an operator sitting in the driver's seat of the motor vehicle.

In the following description, there are shown and described several preferred embodiments of the folding steering wheel. As it should be realized, the folding steering wheel is capable of other, different embodiments and its several details are capable of modification in various, obvious aspects all without departing from the folding steering wheel as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the folding steering wheel and together with the description serve to explain certain principles thereof.

FIG. 1 is a perspective view of the folding steering wheel illustrating the first section of the steering wheel in the home position to allow for normal operation of the motor vehicle.

FIG. 2 is a side elevational view of the folding steering wheel illustrated in FIG. 1 but showing the first section of the folding steering wheel folded into the folded position so as to extend in a substantially horizontal plane and form a support for an open laptop computer.

FIG. 3 is a detailed side elevational view of the pivot and lock of the folding steering wheel.

FIG. 4 is a cross sectional view taken along line 4-4 of FIG. 3 and showing the pivot and lock at both sides of the folding steering wheel.

FIG. 5 is a detailed perspective view illustrating the folding steering wheel in the folded position.

Reference will now be made in detail to the present preferred embodiments of the folding steering wheel, an example of which is illustrated in the accompanying drawing figures.

### DETAILED DESCRIPTION

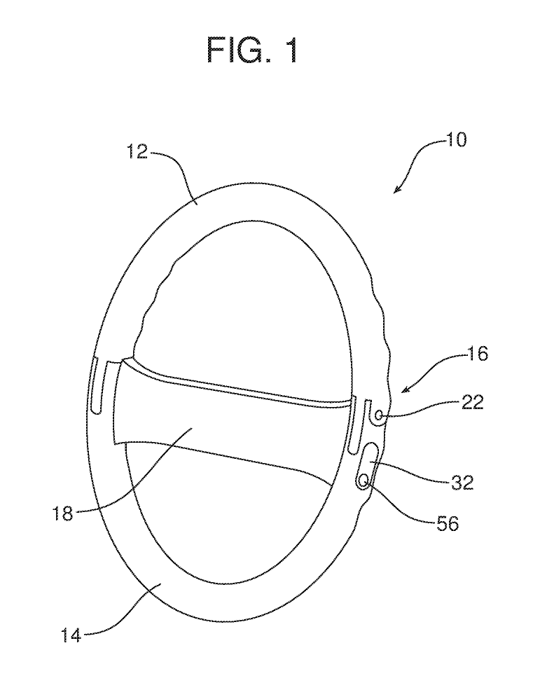

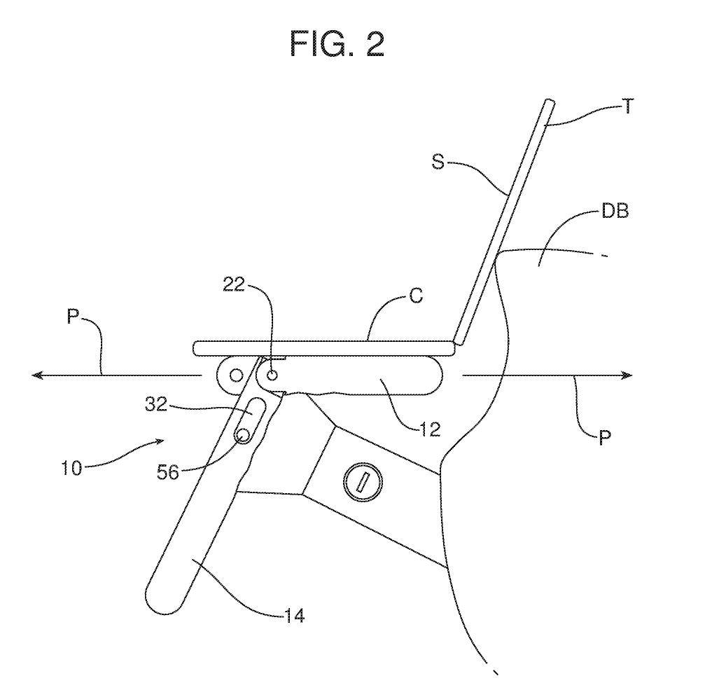

Reference is now made to FIGS. 1-5, illustrating the folding steering wheel 10. That folding steering wheel 10 includes a first section 12, a second section 14 and a pivot 16 connecting the first section to the second section. The first section 12 may be displaced about the pivot 16 with respect to the second section 14 between a home position illustrated in FIG. 1 and a folded position illustrated in FIG. 2.

In the illustrated embodiment, the first section 12 forms an upper portion of the steering wheel rim and the second section 14 forms a lower portion of the steering wheel rim. The second section 14 also carries the hub 18 of the steering wheel.

When the folding steering wheel 10 is in the home position illustrated in FIG. 1, the first section 12 and second section 14 form a continuous circular rim suited for operating the motor vehicle. In contrast, when the first section 12 is displaced into the folded position illustrated in FIG. 2, the first section 12 extends in a substantially horizontal plane. In the folded position, the first section 12 acts as a support for holding a laptop computer C or other device. As illustrated in FIG. 2, the laptop computer C may be stabilized on the first section 12 by abutting the open top T of the laptop against the edge of the dashboard BD. In this position, an operator seated in the driver's seat of the motor vehicle may easily access and operate the laptop computer C in an efficient and effective manner. As should be further noted, the screen S of the laptop computer C is provided at a convenient viewing position, on a line that the driver normally looks through the windshield when driving.

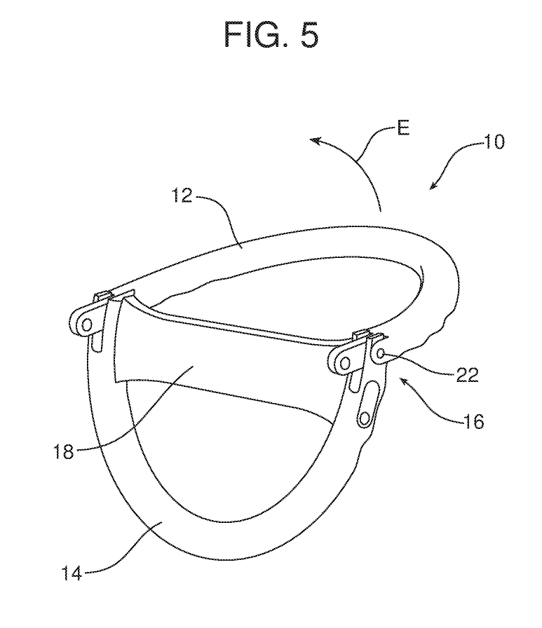

As best illustrated in FIG. 5, the pivot 16 includes a first pivot pin 20 at a first side of the folding steering wheel 10 and a second pivot pin 22 at a second side of the folding steering wheel. The first pivot pin 20 and second pivot pin 22 are aligned along a common pivot axis A so as to allow for free pivoting movement of the first section 12 of the folding steering wheel with respect to the second section 14.

A damper spring 24 may be received around the first pivot pin 20. A second damper spring 26 may be provided around the second pivot pin 22. The two damper springs 24, 26 function to provide smooth fluid movement of the first section 12 between the home position illustrated in FIG. 1 and the folded position illustrated in FIG. 2.

The folding steering wheel 10 also includes a lock, generally designated by reference numeral 28, for releasably securing the first section 12 in the home position. The lock 28 includes a first locking lever 30 and a second locking lever 32 at opposite sides of the folding steering wheel 10. The first locking lever 30 includes a first locking lug 34 at a first end thereof while the second locking lever includes a second locking lug 36 at a second end thereof.

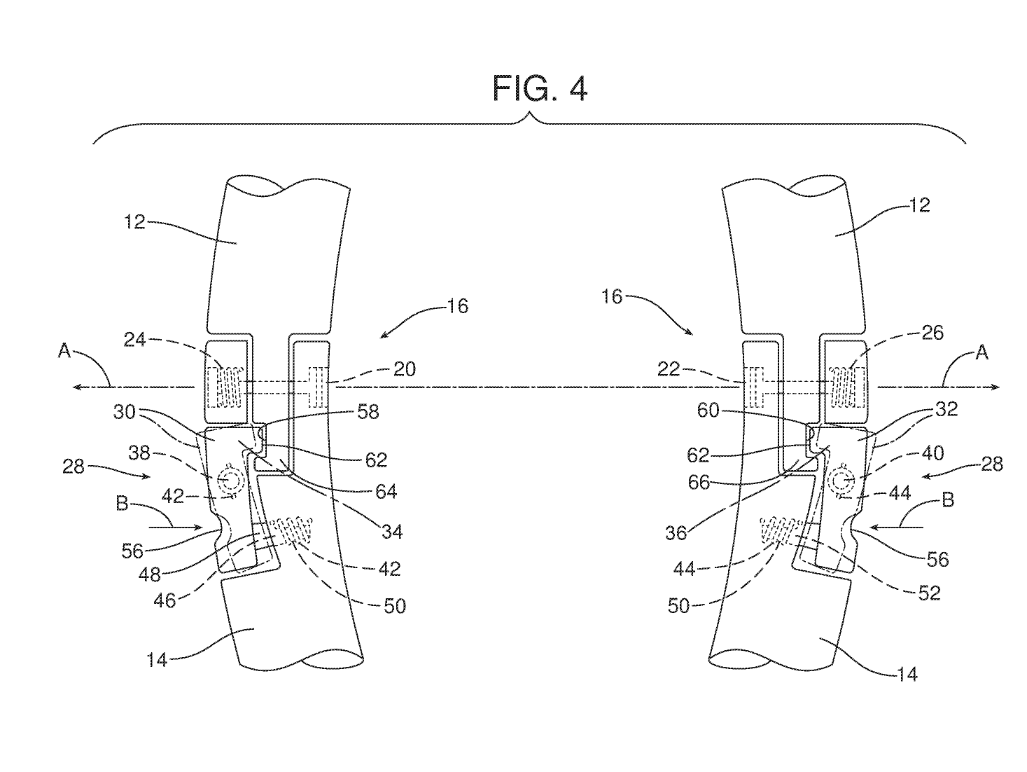

The first locking lever 30 pivots about a first fulcrum 38 with respect to the second section 14 while the second locking lever pivots about a second fulcrum 40 with respect to the second section. A first return spring 42 biases the first locking lever 30 into the first locking position illustrated in full line in FIG. 4. Similarly, a second return spring 44 biases the second locking lever 32 into a second locking position illustrated in full line in FIG. 4. As illustrated in FIG. 4, the first return spring 42 may comprise a coil spring received about the first fulcrum 38 and/or a compression spring held in a cavity 46 in the second section 14 of the folding steering wheel 10 and concentrically received about a lug 48 projecting into that cavity from a second end of the first locking lever 30.

The second return spring 44 may comprise a coil spring received around the second fulcrum 40 and/or a compression spring received in a cavity 50 in the second section 14 of the folding steering wheel 10 that is also received around a second lug 52 projecting from an end of the second locking lever 32 opposite the second locking lug 36.

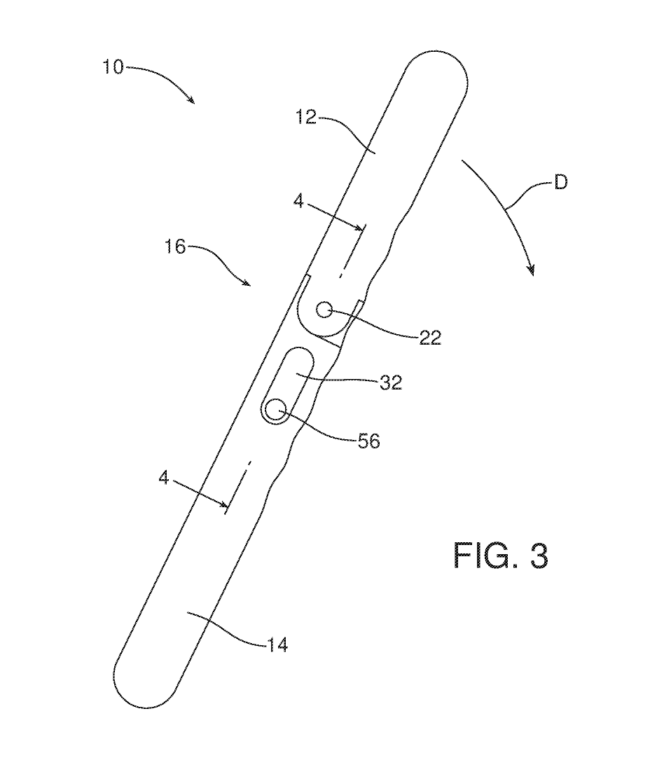

When one wishes to displace the first section 12 of the folding steering wheel 10 with respect to the second section 14 from the home position illustrated in FIG. 1 to the folded position illustrated in FIG. 2, one releases the lock 28 by simultaneously depressing the first locking lever 30 and the second locking lever 32. This is done by pressing inward at the opposed finger depressions 56. See action arrows B in FIG. 4. This action causes the first locking lever 30 and second locking lever 32 to pivot, respectively, about the first fulcrum 38 and second fulcrum 40 into the phantom line positions illustrated in FIG. 4. In the phantom line or release position, the first locking lug 34 is removed from the first receiver 58 provided at a first end of the first section 12 of the folding steering wheel. Similarly, the second locking lug 36 is released from the second receiver 60 in a second end of the first section 12 of the folding steering wheel 10. As a result, the first section 12 may be pivoted in the direction of action arrow D in FIG. 3 into the folded position wherein the first section extends in the substantially horizontal plane P. When the first locking lever 30 and second locking lever 32 are released, the first return spring 42 and second return spring 44 return the locking levers to the full line position illustrated in FIG. 4.

When the first section 12 is in the folded position illustrated in FIGS. 2 and 5, it should be appreciated that the first section 12 forms a substantially horizontal support for holding a laptop computer C or other device where it may be easily accessed and used by an operator seated behind the steering wheel in the driver's seat of the motor vehicle.

When one wishes to return the first section 12 of the folding steering wheel 10 to the home position, one removes the laptop computer C, grasps the middle of the first section 12 and pivots the first section rearward (note action arrow E in FIG. 5) about the first and second pivot pins 20, 22 until the first section of the steering wheel is locked into the home position illustrated in FIG. 1. More specifically, here it should be appreciated that the first locking lug 34 and second locking lug 36 both include angled cam faces 62 that engage the two ends 64, 66 of the first section 12 causing the first and second locking levers 30, 32 to pivot into the phantom line position illustrated in FIG. 4 until the two receivers 58, 60 are aligned to receive the lugs 34, 36. When that alignment occurs, the return springs 42, 44 bias the first and second locking levers 30, 32 into the locking position so that the first locking lug 34 is received in the first receiver 58 and the second locking lug 36 is received in the second receiver 60 so as to then again secure the first section 12 of the folding steering wheel 10 in the home position. Thus, as illustrated in FIG. 1, the first section 12 and second section 14 again form a continuous rim for the proper operation of the motor vehicle.

Consistent with the above description, a method is provided of converting a steering wheel 10 into a support surface for a laptop computer C or other device. That method comprises folding the first section 12 of the steering wheel 10 with respect to the second section 14 until the first section of the steering wheel extends in a substantially horizontal plane P as illustrated in FIG. 2.

That method may also include the step of releasing a lock 28 that secures the first section 12 in a home position illustrated in FIG. 1 before folding the first section of the steering wheel into the folded position illustrated in FIG. 2 where that first section extends in the substantially horizontal plane P. Still further, the method includes the step of positioning the laptop computer C or other device on top of the first section 12 of the steering wheel 10 when that first section is in the folded position as illustrated in FIG. 2.

The foregoing has been presented for purposes of illustration and description. It is not intended to be exhaustive or to limit the embodiments to the precise form disclosed. Obvious modifications and variations are possible in light of the above teachings. For example, while the illustrated embodiment shows the first section 12 of the folding steering wheel 10 at the top and folded forward in FIG. 2 to support the laptop computer C, it should be appreciated that the first section 12 could be provided at the bottom of the folding steering wheel 10 and folded toward the driver to support the laptop computer C if desired. All such modifications and variations are within the scope of the appended claims when interpreted in accordance with the breadth to which they are fairly, legally and equitably entitled.

1. A folding steering wheel, comprising:
a first section;
a second section; and
a pivot connecting said first section to said second section and about which said first section is displaced with respect to said second section between a home position and a folded position.

2. The folding steering wheel of claim 1, further including a lock releasably securing said first section in said home position.

3. The folding steering wheel of claim 2, wherein said pivot includes a first pivot pin aligned with a second pivot pin.

4. The folding steering wheel of claim 3, further including a damper spring received around said first pivot pin.

5. The folding steering wheel of claim 4, wherein said lock includes a first locking lever having a first locking lug at a first end.

6. The folding steering wheel of claim 5, including a first fulcrum about which said first lever pivots.

7. The folding steering wheel of claim 6, including a first return spring biasing said first locking lever into a first locking position.

8. The folding steering wheel of claim 7, wherein said lock includes a second locking lever having a second locking lug at a second end.

9. The folding steering wheel of claim 8, including a second fulcrum about which said second lever pivots.

10. The folding steering wheel of claim 9, including a second return spring biasing said second locking lever into a second locking position.

11. The folding steering wheel of claim 10, further including a hub carried on said second section.

12. The folding steering wheel of claim 2, wherein said lock includes a first locking lever having a first locking lug at a first end.

13. The folding steering wheel of claim 12, including a first fulcrum about which said first lever pivots.

14. The folding steering wheel of claim 13, including a first return spring biasing said first locking lever into a first locking position.

15. The folding steering wheel of claim 14, wherein said lock includes a second locking lever having a second locking lug at a second end.

16. The folding steering wheel of claim 15, including a second fulcrum about which said second lever pivots.

17. The folding steering wheel of claim 16, including a second return spring biasing said second locking lever into a second locking position.

18. A method of converting a steering wheel into a support surface for a laptop computer or other device, comprising:
folding a first section of said steering wheel with respect to a second section of said steering wheel until said first section of said steering wheel extends in a substantially horizontal plane.

19. The method of claim 18, further including releasing a lock that secures said first section of said steering wheel in a home position before folding said first section of said steering wheel into a folded position extending in said substantially horizontal plane.

20. The method of claim 19, further including positioning said laptop computer or said other device on top of said first section of said steering wheel in said folded position.
